(19) United States
(12) Patent Application Publication
(10) Pub. No.: US 2004/0205673 A1
(43) Pub. Date: Oct. 14, 2004

(54) Method for detecting current client-side browser encoding

(76) Inventor: Vladimir Patryshev, Campbell, CA (US)

Correspondence Address: VLADIMIR PATRYSHEV, 277 ESTEBAN WAY, SAN JOSE, CA, 95119, US

(21) Appl. No.: 09/682,576

(22) Filed: Sep. 22, 2001

(51) Int. Cl. G06F 15/00

(52) U.S. Cl. 715/536

(57) ABSTRACT

In order to make the world wide web pages adaptable to the user language and encoding, a method is provided such that the current encoding set on the client browser can be detected within the page being browsed, making it possible to feed-back the encoding to the server side, and also to adapt the page to the language that is most likely to match the native language of the user. To provide this, sample Unicode strings are matched against encoding-specific string values, which are selected in such a way that the match uniquely determines the encoding being currently set. Ordinarily users around the world do not change this setting and often are not aware of it. When the forms are passed back to the server, knowing the encoding of the form data makes it possible to correctly parse the form data and pass them correctly to search engines, to databases, or to other servers.

### BACKGROUND OF INVENTION

The world wide web is being used by millions of users around the world, with different languages. TCP/IP and HTTP protocols transmit data between server and client, in most cases not having the exact knowledge of the language and encoding that the client-side user uses. While Unicode covers all known languages and characters, its encodings, UTF-8 and UTF-16, are very rarely used as a standard for information exchange. Instead, some languages use several different encodings. For instance, there are two widely-used Russian encodings, and two more, less widely used. Many languages have one encoding for Windows operating system and another for DOS. Linux and Unix often use one more encoding; e.g. in Japanese, Shift JIS is widely (but not always) used on Windows, and EUC-JP is widely (but not always) used on Linux and Unix.

Ordinary users around the world do not know and often do not care what encoding they have. It can be a problem when the user downloads a page in a different encoding, but this is solved by specifying page encoding inside HTML. When the users sends a form to the server, though, the server cannot find out the client-side encoding, and can either guess, or keep the data as received, in whatever encoding it was.

This makes searches in international databases almost impossible: for instance, the same set of codes can correspond to different characters in different languages. This also makes it impossible to store data in the server databases in encoding-independent way (which basically means in Unicode).

Some web sites solve this problem by having different pages for different languages; which is still a partial solution for the languages that have several encodings; and since the users, as experience shows, do not know their encoding, the data they supply cannot be always correctly parsed.

Another solution is to retrieve from HTTP request header encodings that are enabled on the client side. This gives only a hint on which languages can be installed on the user's computer. In some occasions it can be enough, when there is one language that has one encoding; in other occasions it is not enough, for instance in the case of a computer being used for Japanese-Ukrainian translation. In this latter case the computer will have at least two languages installed, each of the languages having three different encodings: we have to choose between 7 (add English) encodings.

If the browsers made current encoding available in a JavaScript object on the web page, or to the server in the HTTP request, this would be a solution, but unfortunately this is not so: browsers do not provide this information.

[t1]

Related US Patents:

| U.S. Pat. No. | Date | Author |
|---|---|---|
| 5944790 | July, 1996 | Levy |

[t2]

Other References

| | |
|---|---|
| Peter Kent, John Kent | “Official Netscape JavaScript |
| | 1.2 Book, Second Edition”, |
| | Ventana, 1997. |
| The Unicode Consortium, Joan Aliprand, | “The Unicode Standard, |
| Julie Allen, Rick McGowan, Joe Becker, | Version 3.0”, The Unicode |
| Michael Everson, Mike Ksar, Lisa Moore, | Consortium. |
| Michel Suignard, Ken Whistler, Mark | |
| Davis, Asmus Freytag, John Jenkins | |
| Nadine Kano | “Developing International |
| | Software for Windows 95 and |
| | Windows NT”, Microsoft |
| | Press, 1995 |

### SUMMARY OF INVENTION

The present invention solves the problem of browser encoding detection. The result of detection can be used in a JavaScript program or in a Java applet to adapt the contents depending on the encoding. The result can also be passed to the server, either in consequent HTTP requests, or with the form data. If the form data are accompanied by the encoding name, then the data can be uniquely converted into encoding-neutral Unicode strings.

The method consists of creating an invisible form in the HTML document, with the only hidden input field that contains Unicode character codes for a sample Unicode string, and matching parts of the sample Unicode string with characters or sequence of characters in various specific encodings; when the characters match, the encoding is detected.

### DETAILED DESCRIPTION

The browser encoding is detected in a piece of JavaScript code that is placed in the very top of HEAD part HTML page, before any body text is written to the document. First, a form is written to the document, with th hidden input the value of which is the sample Unicode string, e.g.:document.write(“<form name=VP_encoding><input name=t type=hidden value=‘&#1040;&#192;&#260;&#270;&#901;&#287;&#32;&#32;&#45;&#20491;&#32;’></input></form>”); JavaScript also contains a function, VP_getEncoding( ), that returns the current encoding name. The function works like this:First, it splits the sample Unicode string into two samples, one for multi-byte encodings (multi-byte sample), another for Utf-8 and single-byte encodings (single-byte sample).

The second step detects Utf-8 encoding by comparing the single-byte sample to the same string directly encoded using Utf-8. If the comparison is positive, the algorithm stops.

The third step compares the multi-byte sample string to the same string encoded in Big5 Chinese, GBK Chinese, EUC_TW Chinese, EUC_JP Japanese, SJIS Japanese (the list can be easily extended). Note that the multi-byte sample string is padded with space character, to make it a valid sequence of bytes when the encoding is Utf-8.

The fourth step compares one or two characters of single-byte sample strings to the characters directly encoded using different single-byte encodings. Note that the character cannot be stored alone in the string, but instead has to be padded with space character, to make the sequence legal in Utf-8 encoding. The set of encoding samples can be easily expanded.

If the fourth step does not detect the encoding, “?” is returned.

The function VP_getEncoding( ), can be later used in JavaScript later on the page, or in event handling routines, and the result can be passed back to the server if needed.

Program Listing Deposit

```
<HTML><HEAD><TITLE>Encoding test</title><META HTTP-EQUIV=“Pragma” CONTENT=“no-cache”
<%
    int []det1b = new int[] { 1040, 192, 260, 270, 901, 287 };
// Cyr West CtrE Balt GR Turk
// (with prev)
    int []det2b = new int[] { 0x500b };
// dbl/utf
%>
<form name=“_unicode_”>
<input name=“t1b” type=“hidden” value=“<%
    for (int i = 0; i < det1b.length; i++) {
        out.print(“&#” + det1b[i] + “;”);
    }
%>”></input>
<input name=“t2b” type=“hidden” value=“<%
    for (int i = 0; i < det2b.length; i++) {
        out.print(“&#” + det2b[i] + “;”);
    }
%> ”></input>
</form>
<hr>
<script language=“javascript”>
```

| | | |
|---|---|---|
| <% String[] b2 = new String[] | {“UTF8”, | “\u00e5\u0080\u008b”, |
| | “Big5”, | “\u00ad\u00d3”, |
| | “GBK”, | “\u0082\u0080”, |
| | “EUC_TW”, | “\u00d4\u00b6”, |
| | “EUC_JP”, | “\u00b8\u00c4”, |
| | “SJIS”, | “\u008c\u00c2” }; |

| | | |
|---|---|---|
| String[] b1 = new String[] { | | |
| | “UTF-8”, | “\u00d0\u0090\u00c3\u008 |
| | “Central-European Windows”, | “ \u00a5\u00cf ”, |
| | “Central-European ISO”, | “ \u00a1\u00cf ”, |
| | “Baltic ISO”, | “ \u00a1 ”, |
| | “Cyrillic DOS”, | “\u0080 ”, |
| | “Baltic Windows”, | “ \u00c0 ”, |
| | “Cyrillic Windows”, | “\u00c0 ”, |
| | “Cyrillic KOI-8”, | “\u00e1 ”, |
| | “Cyrillic ISO”, | “\u00b0 ”, |
| | “Turkish”, | “ \u00c0 \u00f0 ”, |
| | “ISO_8859_1”, | “ \u00c0 ”, |
| | “Greek ISO”, | “ \u00b5 ”, |
| | “Greek Windows”, | “ \u00a1 ”, |
| | }; | |

```
%>
    function VP_getEncoding() {
        var encoding = “?”;
        var t1 = document.forms._unicode_.t1b.value;
        var t2 = document.forms._unicode_.t2b.value;
<% // Check for multibyte stuff
        for (int i = 0; i < b2.length; i+=2) { %>
            <%= i > 0 ? “else ” : “” %> if (t2 == “<%= b2[i+1] %> ”) {
                encoding = “<%= b2[i] %>”;
            }<%
        }
    // Check for single-byte stuff
        for (int i = 0; i < b1.length; i+=2) { %>
            if (encoding == “?”) {
<%
                String originalSample = b1[i+1];
                String workingSample = “”;
                int[] chosen = new int[originalSample.length()];
                for (int j = 0; j < originalSample.length(); j++) {
                    char c = originalSample.charAt(j);
                    if (c != ‘ ’) {
                        chosen[workingSample.length()] = j;
                        workingSample += c;
                    }
                }
                if (workingSample.length() == originalSample.length()) {
%>
                if (t1 == “<%= originalSample %>”) {
<%
                } else {
%>
                    test = “<%= originalSample %> ”;
                    if ( <%
                    for (int j = 0; j < workingSample.length(); j++) {
%><%= j > 0 ? “) && ” : “”%> (t1.charAt(<%= chosen[j] %>) == test.charAt(<%= chosen[
                    }%>)) {
<%  } %>
                encoding = “<%= b1[i]%>”;
                }
                }
        <%}%>
            return encoding;
        }
document.write(“Encoding is <font color=red><b>” + VP_getEncoding() + “</b></font><b
</script>
</BODY>
</HTML>
```

1. A method for detecting character set (also known as character encoding) currently selected on the browser on the world wide web client computer system, comprising: a sample Unicode string that contains a set of test character codes which is independent of current client encoding; a plurality of instructions comparing parts of sample Unicode strings with characters or sequences of characters directly encoded using various encodings to be detected; a function that returns the currently selected encoding.

2. The method of claim 1, wherein the scripting programming language comprises a JavaScript programming language.

3. The method of claim 1, wherein the detection is done in three consecutive steps: detection of Utf encodings; detection of multi-byte language encodings; detection of single-byte language encodings.

4. The method of accompanying the form data sent from the web client to the web server with the encoding information collected using method of claim 1.

5. The method of correct form data conversion on the server side based on the accompanying encoding information collected using method of claim 1.
